(19) United States
(12) Patent Application Publication
(10) Pub. No.: US 2023/0252487 A1
(43) Pub. Date: Aug. 10, 2023

(54) System and method for dynamic management and control of air pollution

(71) Applicants: Sichuan academy of environmental Science, Chengdu (CN); Shanghai Readearth Information Technology Co, Ltd., Shanghai (CN)

(72) Inventor: Junhui Chen, Chengdu City (CN)

(21) Appl. No.: 18/096,000

(22) Filed: Jan. 11, 2023

(30) Foreign Application Priority Data
Aug. 3, 2022 (CN) 202210926264.4

(51) Int. Cl. G06Q 30/018

(52) U.S. Cl. CPC G06Q 30/018

(57) ABSTRACT

A system for dynamic management and control of air pollution includes: a multi-source heterogeneous integrated data platform, a comprehensive decision-making one-map platform, an emission inventory management system, a heavy pollution emergency assessment system, a mobile source management system, a source tracking and cause analysis system, and a grid supervision system. A method for dynamic management and control of air pollution includes steps of: detecting problems, making comprehensive decisions, feeding back implementation results, and evaluating effects. The system can collect and produce abundant air pollution related monitoring and forecast data, break the island effect of multi-source heterogeneous data, automatically discover air pollution incidents in an agile and accurate manner, and achieve a high degree of informatization, automation, and quantitative evaluation for air pollution control business process. The method takes full advantages of the data collected by the sensor network and the numerical modes.

### CROSS REFERENCE OF RELATED APPLICATION

The present invention claims priority under 35 U.S.C. 119(a-d) to CN 202210926264.4, filed Aug. 3, 2022.

### BACKGROUND OF THE PRESENT INVENTION

### Field of Invention

The present invention relates to regulation and decision-making business in the field of environmental protection, and more particularly to a system and a method for dynamic management and control of air pollution.

### Description of Related Arts

Air pollution control is an important means for environmental protection executive agencies to control the atmospheric environment. Through discovery, research and treatment of air pollution problems, the regional air quality can be significantly improved.

Conventionally, there are still some difficulties in the implementation of air pollution control business, and the bottleneck of informatization is relatively prominent. First, data silos are prominent, which makes it difficult to integrate multi-source data. Conventionally, although geography, meteorology, environment, and source emission data have supported the development in different fields to a certain extent, it is still necessary to break down the data sharing barriers and gather data from relevant departments to deal with the complex system of environment. In addition, with the accumulation of multi-source data, the relationship between domain data is becoming more and more complex, so it is necessary to use technologies such as big data and artificial intelligence to conduct multi-dimensional in-depth data analysis, thereby meeting the requirements for systematically supporting the pollution prevention and control, as well as promoting the improvement of environmental management precision.

Secondly, the place where the air pollution occurs often has problems such as “special geographical and meteorological conditions” and “complex and rapidly changing pollution source system”. In some places, due to the occlusive geographical space, high discharge, complex terrain and low wind speed, the air pollution often stagnant, which is easy to cause heavy pollution weather under special circulation situation, high humidity and strong temperature inversion events. Air pollution incidents will last for a long time, cover a wide area, and affect a large population. In some areas, the emission enterprises are small in scale and scattered in distribution, and the emission sources are complex.

In addition, it is difficult to perform control measure dynamic response real-time quantitative evaluation. Restricted by hardware conditions and soft scientific foundations such as real-time emission calculation models, the analysis and decision-making of air pollution problems are still based on manual collection and empirical judgment, which can hardly be accurate and timely. Furthermore, due to the constraints of construction system, the conventional local management and control is only implemented at the prefecture-level, lacking unified control at a higher level of the region.

### SUMMARY OF THE PRESENT INVENTION

To overcome the above technical problem, an object of the present invention is to provide a system and a method for dynamic management and control of air pollution. The system implements informatization for each core step of air pollution dynamic management and control, and provides corresponding data support and technical support for each step, which builds a platform-based business application, so as to help the continuous improvement of regional air quality. The system is mainly oriented to the business personnel of environmental protection executive agencies, control target enterprises, environmental protection policy decision-making agencies, etc. The system has strong applicability and versatility, and can scientifically and accurately implement the method of dynamic air pollution control.

Accordingly, the present invention provides: a system for dynamic management and control of air pollution, comprising: a multi-source heterogeneous integrated data platform, a comprehensive decision-making one-map platform, an emission inventory management system, a heavy pollution emergency assessment system, a mobile source management system, a source tracking and cause analysis system, and a grid supervision system.

The multi-source heterogeneous integrated data platform is used to access, store and process various types of data, and provide data capability support to the following platforms. Preferably, the multi-source heterogeneous integrated data platform comprises a basic geographic database, a vehicle dynamic inventory database, a super station integrated database, a source analysis model library and an auxiliary database; wherein the basic geographic database comprises administrative division, river and lake distribution, population distribution, land use and road network basic geographic data; the dynamic vehicle inventory database comprises vehicle registration information data, basic road network information data, real-time traffic flow simulation data, basic emission factor data, motor vehicle environmental impact factor data, and motor vehicle management measure data; the super station integrated database comprises station basic information, instrument basic information, real-time monitoring data, and audit data; the source analysis model library comprises global weather forecasts from forecasting agencies as well as monitoring data from atmospheric and meteorological automatic stations.

Preferably, the multi-source heterogeneous integrated data platform also adapts artificial intelligence technology to enrich data sources and increase observation and analysis angles. The present invention realizes a refined simulation model of urban traffic flow on the whole road network and all time and space, so as to solve the problem that it is difficult for the motor vehicle real-time emission inventory to obtain wide-range high-accuracy average road network speed and traffic flow. The present invention constructs a PMF source analysis result judgment model based on a machine learning method, which is used to solve the problem that conventional source analysis is time-consuming and laborious, and cannot be completed automatically. The present invention realizes a multi-source heterogeneous data fusion technology supported by the artificial intelligence technology, and aims to reduce the application complexity and uncertainty of various atmospheric environment modes caused by differences in spatial resolution, time-response accuracy and storage methods.

The comprehensive decision-making one-map platform is used to integrate and display information of monitoring sites and enterprise emissions. Preferably, the comprehensive decision-making one-map platform has access to national and provincial environment monitoring site data, super station data, micro station data and meteorological wind field data; for enterprise emissions, the comprehensive decision-making one-map platform also has access to enterprise information, emission inventories, heavy pollution emergency emission reduction inventories, environmental statistics, and enterprise system evaluation data.

The emission inventory management system is used to prepare, fill and calculate emission inventories. Preferably, the emission inventory management system establishes a standardized emission inventory preparation method, a management system and an operational management tool according to “Guidelines for the Preparation of Emission Inventory Technology” promulgated by the Ministry of Ecology and Environment of the People's Republic of China; the emission inventory management system integrates air pollution emission source information collection, inventory accounting, data quality control, visual analysis, dynamic update, and model docking.

Preferably, the emission inventory management system can view the inventory filling task and the task countdown, and displays the detailed information of the corresponding enterprises according to different industries. The system realizes the inventory approval work through three-level audit, and the system is capable of diagnostic audit and progress supervision. Based on the national inventory guidelines, a factor library suitable for local conditions is compiled in combination with local conditions. The system supports the automatic calculation of pollutant emissions of each enterprise based on the activity level filled in by enterprises, the factor library, and an inventory algorithm model; the system also supports separate statistical analysis according emission sources and administrative divisions.

The heavy pollution emergency assessment system is used to quantify heavy pollution weather processes, and to evaluate and prepare emergency management and control schemes. Preferably, the heavy pollution emergency assessment system provides visual decision support centered on short-term air quality improvement, which quantitatively analyzes emission intensity changes of pollution sources under various control scenarios, selects an optimal emergency management and control scheme through various scenario simulations, and prepares a special analysis report on regional pollution processes based on pre-forecasting, in-event analysis, and post-event evaluation.

The mobile source management system is used to calculate, monitor, govern and evaluate mobile source emissions. Preferably, the mobile source management system performs high-resolution real-time dynamic analysis of regional mobile sources through traffic flow analysis and flow density models; through model evaluation of emission reduction measures involving vehicle, oil and road, emission reduction effects on air quality are quantified, so as to build a dynamic policy evaluation system based on mobile source supervision-governance-evaluation.

The source tracking and cause analysis system is used for online analysis of pollution causes, and for preparation of research and judgment reports. Preferably, the source tracking and causes analysis system integrates observation data and numerical model results provided by the multi-source heterogeneous integrated data platform to realize pollution source traceability, online source analysis, ozone cause analysis, pollution process dynamic assessment, small-scale source analysis, and intelligent drafting. Preferably, the pollution source traceability provided by the system is connected to national, provincial and local atmospheric stations, national surface meteorological stations and weather auxiliary analysis data. The observation data of super stations are integrated to perform particulate matter composition, photochemical and vertical sounding analysis on the basis of data quality control. A backward trajectory model, trajectory clustering and potential source contribution algorithm are integrated to analyze the possibility of pollution transmission according to the trends. PM2.5 online source analysis solution based on CMB is provided. PMF traceability analysis of particulate matter and VOCs is provided, which can be combined with local pollution source characteristics (source tracers) to realize dynamic identification of emission pollution sources. Ozone control assessment, relative incremental activity comparison and EKMA curve drawing functions based on OBM model analysis are provided. Model source analysis based on air quality modes is provided. Analysis of inter-regional transmission contribution and industry emission contribution is provided. Automatic report template generation function is provided to edit and export reports online according to requirements.

The grid supervision system is used for inspection, early warning, commanding and evaluation of an environmental protection supervision grid system. Preferably, the grid supervision system detects problems based on alarm warning of each monitoring site and daily inspection, so as to integrate an automatic mode and a manual mode for scheduling and controlling.

According to the present invention, a method for dynamic management and control of air pollution comprises steps of: detecting problems, making comprehensive decisions, feeding back implementation results, and evaluating effects; wherein detailed explanation of each step is as follows.

Detecting the problems comprises automatically or manually judging occurrence or possible occurrence of pollution problems according to data through the comprehensive decision-making one-map platform provided by the system for the dynamic management and control of the air pollution.

Preferably, in order to identify pollution problems, massive heterogeneous related data are needed. In the field of air pollution, the main data of concern are: meteorological live monitoring data, environmental live monitoring data, numerical forecast data, model forecast data and other data. The system for the dynamic management and control of the air pollution accesses all the aforementioned data through the multi-source heterogeneous integrated data platform, and makes an integrated display on the comprehensive decision-making one-map platform.

Preferably, the air pollution problem defined in the system comprises excessive pollutant concentration at monitoring sites, video identification of key pollution source emissions, potential pollution process predicted by forecasting models, regional pollution retrieved from remote sensing data, and fire spots detected by satellite monitoring.

The excessive pollutant concentration at monitoring sites refers to that the system automatically screens the real-time site monitoring data according to the preset excessive judgment rules, and pushes the sites that meet the excessive judgment rules to a client through an automatic alarm function; or the user browses real-time monitoring data provided by the system and actively determines that the site has a high possibility of excessive pollutant concentration.

The video identification of key pollution source emissions refers to using an artificial intelligence video recognition technology to real-time check monitoring videos of key pollution sources, and if excessive discharge of pollutants is identified, the user will be informed through the automatic alarm function.

The potential pollution process predicted by forecasting models refers to using a numerical simulation technology to predict concentration changes and spatial transmission of air pollutants in the future. According to the results, it is judged whether air pollution incidents will occur at a specific time and in a specific area in the future. If pollution incidents may occur, a report will be generated through an automatic forecast analysis report function and pushed to the client.

The regional pollution retrieved from remote sensing data refers to using a remote sensing image retrieval technology to obtain the concentration of regional air pollutants, wherein air pollution status is analyzed according to the excessive concentration standard, so as to determine the regional air pollution problems with the help of local monitoring situations. Problem analysis reports can be generated through an automatic reporting function.

The fire spots detected by satellite monitoring refers to using satellite monitoring technology and image recognition technology to implement real-time monitoring and detection of fire spots within the monitoring range. If a fire spot is detected, it will be timely reported to relevant personnel by the system.

Preferably, after the system automatically identifies the problem or the user finds the problem under the support of the system, the problem report function of the platform can be used to compile a problem report, and the relevant personnel can be notified in the system for comprehensive research and judgment.

Making the comprehensive decisions comprises performing multi-angle research and judgment on occurred or potential pollution incidents through the relevant subsystems provided by the system for the dynamic management and control of the air pollution, and generating cause analysis reports and precise control schemes based on pollution types according to relevant schemes.

Preferably, in order to make accurate pollution control decisions, it is necessary to conduct weather situation research and judgment, multi-dimensional traceability analysis, and emission source control.

The weather situation research and judgment refers to using meteorological live monitoring products, meteorological condition forecast products, and air mass trajectory analysis products, together with excessive pollutant information from national, provincial control and micro stations in the air quality monitoring network, to analyze and obtain the areas affected by adverse meteorological conditions and the pollution transmission direction, so as to further analyze key areas.

The multi-dimensional traceability analysis refers to using multi-model analysis to obtain the main source of pollution discharge based on multi-source heterogeneous big data, wherein analysis methods may vary according to the characteristics of pollution problems. For the regional pollution process, it is necessary to use dynamic source analysis based on component online monitoring, AI source spectrum identification, three-dimensional model simulation traceability based on dynamic source inventory, and photochemical model ozone simulation based on observation, so as to identify the main particulate matter or gas components which caused the pollution and the key emission sources thereof. For emergency pollution incidents with uncertain pollution sources, pollution impact analysis should be carried out based on monitoring methods such as high-value spot exceeding alarm and satellite fire spot, so as to determine investigation scope of pollution sources around the problem spot by using air mass trajectory simulation, small-scale air quality simulation and other analysis methods.

The emission source control refers to emission reduction simulation based on a three-dimensional model air quality simulation based on a high-resolution dynamic emission inventory, and an emission reduction measure library, so as to screen the optimal control schemes for the pollution incidents. The high-resolution dynamic emission inventory and the emission reduction measure library refer to docking an emission inventory and emission reduction measure information with a model based on the emission inventory management system and the mobile source management system, thereby forming a high-resolution dynamic mode inventory and emission reduction schemes required for mode simulation, wherein the management and control measures for industrial sources with complex classification can be refined to industry-enterprise, and the management and control measures for road mobile sources can be refined to the four levels of “vehicle-oil-road-pipe”. According to the pollution severity and key source objects, a variety of scenarios can be set up online to obtain management and control simulation results after the combination of different schemes, which is conducive to screening out the optimal management and control schemes.

Preferably, through the above research and analysis, the system research and judgment reports based on different analysis report templates, such as daily urban air quality analysis report in the region, traceability analysis report based on component observation, industry and regional source pre judgment daily report. The reports can be edited and exported online according to demands. The system analysis results can be a reference to assist business personnel and expert groups to analyze and discuss the pollution process and to decide management and control scheme.

Feeding back the implementation results comprises performing task management of air pollution prevention and control through the grid supervision system, and establishing a closed-loop management mode formed by problem discovery, traceability, treatment and feedback.

The grid supervision system is designed based on tasks and workflow, with task management as the core, users as nodes, and task push trajectory as the process, so as to realize the whole process supervision of task issuance-task execution-task tracking. By sorting out the responsibilities of relevant departments of air pollution control, unified scheduling and coordination are carried out for grid tasks, annual special tasks, stage special tasks, and atmospheric analysis tasks, thereby ensuring the effective implementation of environmental protection management and control measures.

Preferably, the grid tasks mainly refer to that local grid personnel find problems in the daily inspection work, and upload information such as the problem type, on-site actual situation, on-site photos and other information through the terminal software provided by the system. To complete the annual special tasks, the annual special tasks refer to tasks uniformly implemented and issued by governments at all levels, wherein such tasks are assigned to the governments at all levels according to the relevant rules and regulations and the division of responsibilities based on the special task inventory of annual air quality target of the regional competent authority. To complete the stage special tasks, stage special tasks refer to the introduction of air pollution prevention and control actions during special stages such as heavy pollution emergency, autumn and winter control, and summer ozone prevention and control. To complete the atmospheric analysis tasks, the atmospheric analysis tasks refer to tasks issued according to research and judgement results as well as department supervision responsibilities, which depends on meteorological effects of pollution sources and emission effects of key pollution sources analyzed by excessive pollutants and pollution traceability technology.

Preferably, rectification measures and rectification time limit are proposed according to task description and responsible units, wherein a problem list is classified and summarized for the later decision evaluation of pollution source risk management and control, and superior concerning tasks are highlighted.

Preferably, responsible unit users execute the tasks in accordance with relevant task information and rectification suggestions, or assign the tasks to companies, streets and other subordinate units to complete rectification within the specified time limit. Illegal acts should be punished and punishment should be reported in accordance with law.

Preferably, users of the supervision department track the issued tasks in real time, receive inspection and feedback materials, ensure the implement and orderly execution of various tasks, issue real-time alarms for tasks approaching the rectification time limit, and urge the responsible person through text messages, emails, etc. The person in charge of the task but fail to rectify on time will be held accountable and punished. The task, which has reported feedback materials and been canceled, will be reviewed and approved, wherein the task that meets the rectification regulations will be approved, and the task that fails to meet the rectification regulations will be marked as unqualified content, and the relevant responsible person should continue to complete the task until the rectification requirements are met.

On the one hand, the task scheduling mechanism of the grid monitoring system realizes inter-departmental scheduling information sharing; on the other hand, it can also assist the daily management of business personnel, which reduces the work intensity of monitoring personnel and improves the work efficiency of the whole process.

Evaluating the effects comprises evaluating implementation degree of emission reduction measures and improvement effects of air quality by an air quality dynamic regulation effect evaluation technology, which is performed with reference to key source online monitoring data and measured air quality data during and after heavy pollution processes, so as to quantify actual effects of the emission reduction measures.

Evaluating the implementation degree of the emission reduction measures refers to comparing and evaluating the production situation changes and spatial distribution before and after the implementation of emission reduction based on key source real-time actually measured data such as traffic flow monitoring and online monitoring of industrial enterprise emissions, comprising enterprise sulfur dioxide, particulate matter, nitrogen oxide emissions, and electricity consumption, to analyze whether the emission reduction measures are implemented and whether there is a desired reduction ratio is reached. The implementation progress of the emission reduction measures of each responsible entity can be tracked through daily summary of the measure requirements, the number of dispatched persons, the number of dispatched vehicles, the number of inspections, the number of inspection projects/enterprises, the number of work/production suspensions, the number of violations, the number of penalties, and the inspection time of the relevant departments of each city-county (city, district) during the heavy pollution emergency period, as well as the total number of key control enterprises, the number of reported enterprises, the number of suspended enterprises, the number of production-restricted enterprises, the number of enterprise production line control, and the daily emission reduction (daily emission reduction of particulate matter, SO₂, NOx, VOCs (kg)/day)), which also provides a basis for the subsequent assessment of whether the department has performed its duties and whether the enterprise has illegal discharge behaviors.

Evaluating the improvement effects of air quality refers to using the measured air quality data and refined forecast data to compare and evaluate pollution levels and major pollutant concentrations before and after the implementation of the emission reduction, and to analyze the improvements of the air quality caused by the emission reduction scheme. During the heavy pollution process, emergency emission reduction schemes implemented are daily evaluated, so as to adjust the scheme in time according to the improvement effects.

Preferably, the effect evaluation needs to be quantified through a variety of indicators.

The evaluation index of the implementation degree of the emission reduction measures is a gap between the measured production data and the simulated ratio of the emission reduction scheme, wherein a smaller gap indicates a higher implementation degree. Furthermore, the gap is compared with the source spatial distribution information, wherein if year-on-year decline ratio distribution is closer to pollution source distribution involved in the scheme, then the implementation of the measures is more comprehensive.

The evaluation index of the improvement effects of air quality are the concentration improvement ratios and air quality grade changes before and after emission reduction, the higher the better. In addition, for the regional joint prevention and control schemes, the “city·time” of pollution occurrence is used as a frequency unit to calculate, and the more the frequency drops, the better the improvement effect is.

In addition, by establishing a local pollution case database to analyze the heavy pollution processes of similar weathers in history, the effects of meteorology and emission reduction on air quality can be analyzed separately by applying a post-evaluation method of meteorology-air quality-control measures on similar cases, which provides reference for the preparation of emergency management and control schemes.

Beneficial effects: compared with the prior art, the present invention has the following advantages:

(1) The present invention provides a system for dynamic management and control of air pollution, comprising: a multi-source heterogeneous integrated data platform, a comprehensive decision-making one-map platform, an emission inventory management system, a heavy pollution emergency assessment system, a mobile source management system, a source tracking and cause analysis system, and a grid supervision system. The system can collect and produce abundant air pollution related monitoring and forecast data, break the island effect of multi-source heterogeneous data, automatically discover air pollution incidents in an agile and accurate manner, and achieve a high degree of informatization, automation, and quantitative evaluation for air pollution control business process. The system adopts multi-level linkage and multi-screen linkage to realize a closed-loop air pollution control business.

(2) The present invention provides a method for dynamic management and control of air pollution, comprising steps of: detecting problems, making comprehensive decisions, feeding back implementation results, and evaluating effects. The method takes full advantages of the data collected by the sensor network and the numerical modes to realize problem discovery and judgment, which can quickly apply cutting-edge analysis technology, fully mobilize the executive power of multi-level control personnel, and improve the scientific and systematic nature of air pollution dynamic control business.

(3) The AI-based multi-source heterogeneous database fusion technology constructed by the method of the present invention can integrate various data of the order of tens of billions, which performs standardized and uninterrupted processing of multi-source, multi-parameter and multi-dimensional data sets, performs multi-dimensional monitoring, performs multi-level operation and maintenance, and performs multi-tool auditing to ensure data quality. Online simulation capabilities are comprehensively improved. And stream computing methods can greatly improve computing efficiency.

(4) The method of the present invention can provide precise traceability and dynamic control technology for atmospheric compound pollution, which has the advantage of comprehensively researching, judging and forecasting the regional weather situation, providing 48-hour hour-by-hour refined air quality forecast, and improving the forecast accuracy. The time resolution of high-resolution dynamic inventory has been increased from annual to hourly level. The identification of ozone pollution control areas can be daily provided. The time resolution of VOCs and PM2.5 source analysis has been improved from monthly offline analysis to hourly dynamic update. The spatial resolution has been increased from city scale and industry scale to park scale and enterprise scale. The error of numerical simulation and receptor model results has been significantly improved. A closed-loop control technology system is provided for performing rapid countermeasures and daily rolling evaluation.

(5) The regional composite pollution dynamic control and decision-making platform construction technology realized by the method of the present invention has the advantages of multi-terminal linkage between the management and control platform and the mobile terminal, integrated command and scheduling, smooth data sharing between departments and administrative divisions, and thoroughly fulfilling of tasks, which turn the conventional environmental governance methods to digital ones.

### BRIEF DESCRIPTION OF THE DRAWINGS

FIG. 1 is a block diagram of a system for dynamic management and control of air pollution according to the present invention; and

FIG. 2 is a flow chart of the system for the dynamic management and control of the air pollution according to the present invention.

### DETAILED DESCRIPTION OF THE PREFERRED EMBODIMENT

Referring to the drawings and embodiment, the present invention will be further illustrated.

The present invention provides a system and a method for dynamic management and control of air pollution, which takes “ detecting problems—making comprehensive decisions—feeding back implementation results—evaluating effects ” as the main line. The present invention is mainly oriented to environmental protection service departments, environmental protection law enforcement departments and emission enterprises to perform prevention, early warning, integrated control and evaluation study of air pollution incidents. The present invention improves the informatization level of the air pollution dynamic management and control business, forms a business closed loop for multi-level and multi-departments, and can identify the air pollution problem from the source and formulate scientific and effective measures to implement the management and control, thereby realizing the scientific management of the air pollution problem.

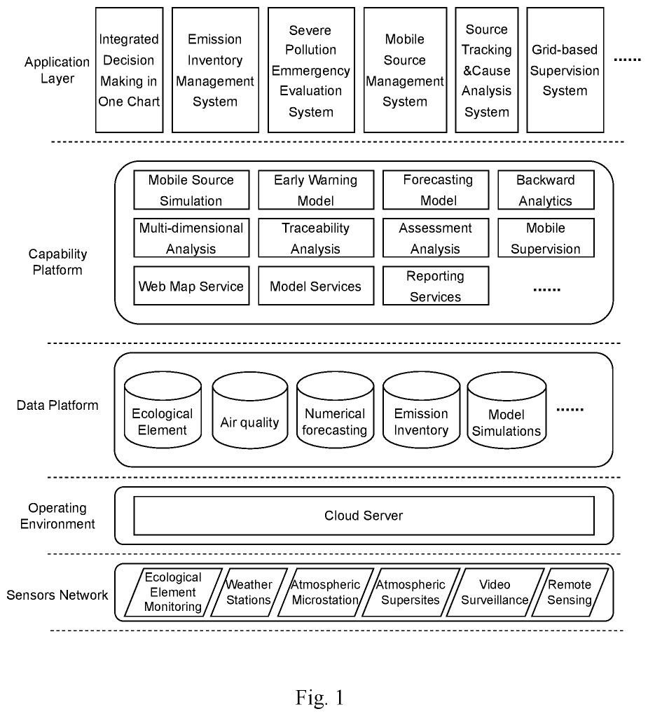

Referring to FIG. 1, the present invention provides a system for dynamic management and control of air pollution, comprising: a multi-source heterogeneous integrated data platform, a comprehensive decision-making one-map platform, an emission inventory management system, a heavy pollution emergency assessment system, a mobile source management system, a source tracking and cause analysis system, and a grid supervision system; wherein the multi-source heterogeneous integrated data platform is used to access, store and process various types of data, and provide data capability support to the following platforms; the comprehensive decision-making one-map platform is used to integrate and display information of monitoring sites and enterprise emissions; the emission inventory management system is used to prepare, fill and calculate emission inventories; the heavy pollution emergency assessment system is used to quantify heavy pollution weather processes, and to evaluate and prepare emergency management and control schemes; the mobile source management system is used to calculate, monitor, govern and evaluate mobile source emissions; the source tracking and cause analysis system is used for online analysis of pollution causes, and for preparation of research and judgment reports.

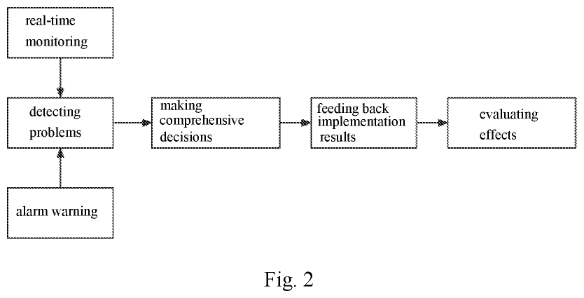

Referring to FIG. 2, the system of the present invention can be used for emergency response and control of air pollution incidents, so as to complete the whole process of dynamic air pollution control, comprising aggregating data, detecting problems, making comprehensive decisions, feeding back implementation results, and evaluating effects, thereby performing forecast, early warning and scientific management of air pollution incident.

An air pollution incident that occurred in a certain time area in the past is selected as an example, and the method of the present invention was used to perform dynamic control measures for this pollution incident through the system. The specific process was as follows:

1. Description of the pollution process. From Jan. 10 to 14, 2022, there was a pollution process in this area. According to an online data analysis module of the system, it was concluded that the AQI was above 100 during this period, and reached the highest value of 160 on the 12th, which means the air quality level is moderate pollution. The primary pollutants during this period were all PM2.5, with an average value of 118 mg/m³ and a maximum value of 161 mg/m³. From the 10th, the northerly wind prevailed in the area but was weak, the weather was fine during the day, and the temperature difference between day and night was large.

2. Analysis of pollution causes. A source tracking and cause analysis system and a source tracking module were combined for analyzing, it was concluded that during this pollution process, the area was in a situation of high-uniform circulation, resulting in a small surface pressure difference, high frequency of still wind, fog and temperature inversion. According to the super station observation of the Provincial Academy of Environmental Sciences, the minimum boundary layer in this area was less than 200 meters, and the frequency of still winds was 99.1%. On the evening of the 12th, there was a ground inversion temperature, reaching 11.43° C./100 meters. Such a rare and strong temperature inversion resulted in extremely unfavorable diffusion conditions, and the pollutants stayed for a long period of time. On the other hand, according to the data provided by the online data analysis module of the system, the rapid secondary conversion and continuous accumulation of NOx was the main reason for the increase of regional PM2.5. Since the 10th, as the PM2.5 concentration had gradually increased, which increased and the pollution level. The area had changed from a partial comprehensive feature (10-12th) to a partial secondary pollution feature (13-14th). Except the western region had the partial secondary pollution feature with mild pollution on the 12th, the rest regions all had coarse particulate feature, indicating that they were significantly affected by urban dust emissions. On the 13th, moderate pollution occurred in the southern part of the region, the PM2.5 characteristic value increased significantly, and the NOx characteristic value gradually decreased, indicating that the secondary conversion of NOx emissions was the main cause of pollution, involving kiln industry, motor vehicles, and gas boilers. From the 13th to the is 14th, all areas showed partial secondary pollution feature, and the NOx characteristic value dropped significantly, indicating that the secondary conversion of NOx contributed significantly. According to the super station observation results on the air quality decision-making platform, the nitrogen oxidation rate (NOR) was up to 0.63, which was 1 to 3 times that of the non-pollution period. To sum up, the extremely unfavorable diffusion conditions and the rapid accumulation of pollutants caused the unqualified air quality in this area.

3. Pollution response and effect evaluation. Through the command and scheduling module of the decision support platform, experts were gathered to the region for discussion about this pollution process, so as to submit proposals to relevant department leaders based on local pollution characteristics, comprising early warning measures and yellow warnings. The proposals were published after approved on the platform by the leaders. According to the latest emission reduction inventory for heavy pollution weathers and the emergency plan in the command and scheduling module, the enterprise took differentiated emergency emission reduction measures according to the environmental performance level (the platform provided an emission reduction measure library), thereby implementing mobile source management, and timely reporting the implementation status to relevant departments. Mode simulation evaluation results of the effectiveness of the emergency management and control measures taken during this pollution process showed that the pollution in the province was delayed by 1 day, 2 good days were recovered, the mild pollution was reduced by 2 days, and the regional PM2.5 concentration decreased by 6%. After the regional warning was activated, major industrial air pollutants were reduced by 9%.

4. Short-term forecast. With the help of the forecast module in the heavy pollution emergency assessment system of the platform, the forecast results of various forecast methods were combined to forecast the future air quality of the region. In the next 24 hours, starting from the early morning of the 15th, cold air would enter the area, affecting this part of the area from north to south, the wind would be relatively strong, and the air quality was expected to turn cooler; in the next week, more precipitation would be generated in this area, it was expected that the deposition effect would be clear and obvious on the pollutants, and the air quality would range from excellent to good; in the medium and long term, from the 27th to the 28th, weak cold air would affect the northeast of the region, and the southern region would have a moderate risk of pollution; from the 30th to the 31st, pollutants would continue to accumulate, the circulation situation may become “highly uniform”, and moderate to severe pollution might occur in many cities. It was expected that on February 2nd-3rd, cold air would appear again, and the pollution process would end. In addition, there might be a cross-year haze in mid-February, and the numerical forecast indicated that the pollution level would mainly be mild.

5. Countermeasures and suggestions. Through the heavy pollution emergency management system of the platform, suggestions for the next management and control work were put forward based on early warning and forecast. The first was to strengthen regional joint prevention and control. In response to unfavorable meteorological processes, according to the early warning and forecast, emergency management and control measures could be activated in the platform command and scheduling system in advance, in such a manner that emergency plans could be activated to implement regional joint prevention and control, increase regional emission reduction, minimize pollution accumulate and reduce the pollution level. Secondly, the coordinated control of NOx and VOCs should be strengthened to focus on strengthening the emission control of NOx elevated sources in the region and surrounding areas, as well as the management and control of mobile sources in the region, and to strengthen VOCs emission control for near-ground chemical industry, industrial coating, motor vehicles, etc. Finally, emergency management and control measures should be strictly implemented. In the early stage of this round of pollution, most cities had coarse particulate feature, and later changed to secondary pollution feature. All the cities were suggested to further strengthen regular control measures such as watering, adopt on-site supervision in key areas, upgrade control during key periods, strictly implement certain policy for certain plant and emission reduction inventory control measures, and provide timely feedback on the implementation through the platform.

Based on the method for dynamic management and control of air pollution, the present invention establishes the system for dynamic management and control of air pollution, which realizes an air pollution management and control closed-loop formed by “detecting problems—making comprehensive decisions - feeding back implementation results—evaluating effects”. The system integrates massive multi-source heterogeneous data such as geography, meteorology, environment, and pollution sources in the region, forming a complete data quality control mechanism. The system adopts the artificial intelligence technology to build a highly integrated database covering terrain, meteorology, source emissions, and control measures. The innovative application of flow computing method helps to establish an uninterrupted process of “data collection—analysis and application”, which integrates localized multi-scale air quality models to form an informatized control system with “high-precision source inventory—accurate traceability—dynamic management and control”. The system is highly informatized in the whole process of the dynamic management and control of the air pollution, which has high convenience and versatility. The system can also be flexibly docked with other systems for data sharing and service support, showing high flexibility and scalability.

The above-mentioned embodiment is only a preferred embodiment of the present invention. It should be noted that for those skilled in the art, without departing from the principles of the present invention, several improvements and equivalent replacements can be made. The technical solutions with such improvements and equivalent replacements are all within the protection scope of the present invention.

What is claimed is:

1. A system for dynamic management and control of air pollution, comprising: a multi-source heterogeneous integrated data platform, a comprehensive decision-making one-map platform, an emission inventory management system, a heavy pollution emergency assessment system, a mobile source management system, a source tracking and cause analysis system, and a grid supervision system; wherein
the multi-source heterogeneous integrated data platform is used to access, store and process various types of data, and provide data capability support to the following platforms;
the comprehensive decision-making one-map platform is used to integrate and display information of monitoring sites and enterprise emissions;
the emission inventory management system is used to prepare, fill and calculate emission inventories;
the heavy pollution emergency assessment system is used to quantify heavy pollution weather processes, and to evaluate and prepare emergency management and control schemes;
the mobile source management system is used to calculate, monitor, govern and evaluate mobile source emissions;
the source tracking and cause analysis system is used for online analysis of pollution causes, and for preparation of research and judgment reports; and
the grid supervision system is used for inspection, early warning, commanding and evaluation of an environmental protection supervision grid system.

2. The system, as recited in claim 1, wherein the multi-source heterogeneous integrated data platform comprises a basic geographic database, a vehicle dynamic inventory database, a super station integrated database, a source analysis model library and an auxiliary database;
wherein the basic geographic database comprises administrative division, river and lake distribution, population distribution, land use and road network basic geographic data; the dynamic vehicle inventory database comprises vehicle registration information data, basic road network information data, real-time traffic flow simulation data, basic emission factor data, motor vehicle environmental impact factor data, and motor vehicle management measure data; the super station integrated database comprises station basic information, instrument basic information, real-time monitoring data, and audit data; the source analysis model library comprises global weather forecasts from forecasting agencies as well as monitoring data from atmospheric and meteorological automatic stations.

3. The system, as recited in claim 1, wherein the comprehensive decision-making one-map platform has access to national and provincial environment monitoring site data, super station data, micro station data and meteorological wind field data; for enterprise emissions, the comprehensive decision-making one-map platform also has access to enterprise information, emission inventories, heavy pollution emergency emission reduction inventories, environmental statistics, and enterprise system evaluation data.

4. The system, as recited in claim 1, wherein the emission inventory management system establishes a standardized emission inventory preparation method, a management system and an operational management tool according to “Guidelines for the Preparation of Emission Inventory Technology” promulgated by the Ministry of Ecology and Environment of the People's Republic of China; the emission inventory management system integrates air pollution emission source information collection, inventory accounting, data quality control, visual analysis, dynamic update, and model docking.

5. The system, as recited in claim 1, wherein the heavy pollution emergency assessment system provides visual decision support centered on short-term air quality improvement, which quantitatively analyzes emission intensity changes of pollution sources under various control scenarios, selects an optimal emergency management and control scheme through various scenario simulations, and prepares a special analysis report on regional pollution processes based on pre-forecasting, in-event analysis, and post-event evaluation.

6. The system, as recited in claim 1, wherein the mobile source management system performs high-resolution real-time dynamic analysis of regional mobile sources through traffic flow analysis and flow density models; through model evaluation of emission reduction measures, emission reduction effects on air quality are quantified, so as to build a dynamic policy evaluation system based on mobile source supervision-governance-evaluation.

7. The system, as recited in claim 1, wherein the source tracking and causes analysis system integrates observation data and numerical model results provided by the multi-source heterogeneous integrated data platform to realize pollution source traceability, online source analysis, ozone cause analysis, pollution process dynamic assessment, small-scale source analysis, and intelligent drafting.

8. The system, as recited in claim 1, wherein the grid supervision system detects problems based on alarm warning of each monitoring site and daily inspection, so as to integrate an automatic mode and a manual mode for scheduling and controlling.

9. A method for dynamic management and control of air pollution based on the system as recited in claim 1, comprising steps of: detecting problems, making comprehensive decisions, feeding back implementation results, and evaluating effects;
wherein detecting the problems comprises automatically or manually judging occurrence or possible occurrence of pollution problems according to data through the comprehensive decision-making one-map platform provided by the system for the dynamic management and control of the air pollution;
making the comprehensive decisions comprises performing multi-angle research and judgment on occurred or potential pollution incidents through the relevant subsystems provided by the system for the dynamic management and control of the air pollution, and generating cause analysis reports and precise control schemes based on pollution types according to relevant schemes;
feeding back the implementation results comprises performing task management of air pollution prevention and control through the grid supervision system, and establishing a closed-loop management mode formed by problem discovery, traceability, treatment and feedback; and
evaluating the effects comprises evaluating implementation degree of emission reduction measures and improvement effects of air quality by an air quality dynamic regulation effect evaluation technology, which is performed with reference to key source online monitoring data and measured air quality data during and after heavy pollution processes, so as to quantify actual effects of the emission reduction measures.
